(19) United States
(12) Patent Application Publication
(10) Pub. No.: US 2005/0200874 A1
(43) Pub. Date: Sep. 15, 2005

(54) Driver management method, system, unit and program

(75) Inventors: Makoto Oshiumi, Saibama (JP); Yoshiaki Hatano, Kanagawa (JP); Tatsuya Chihara, Kanagawa (JP)

Correspondence Address: OLIFF & BERRIDGE, PLC, P.O. BOX 19928, ALEXANDRIA, VA, 22320, US

(73) Assignee: Fuji Xerox, Co., Ltd., Tokyo (JP)

(21) Appl. No.: 10/961,269

(22) Filed: Oct. 12, 2004

(30) Foreign Application Priority Data
Mar. 12, 2004 (JP) 2004-070920
Mar. 17, 2004 (JP) 2004-076902

(51) Int. Cl. G06F 15/00

(52) U.S. Cl. 358/1.13; 358/1.15

(57) ABSTRACT

A driver management method for a driver management unit to manage a device driver to be installed in terminal devices which use a device connected to a network, comprising: monitoring a driver storage unit in which the device driver for using the device is stored, when the device driver stored in the driver storage unit is updated, specifying a terminal device into which the updated device driver is installed, and installing the updated device driver into the specified terminal device.

### BACKGROUND OF THE INVENTION

1. Field of the Invention

The present invention relates to a driver management method, system, unit and program, and more particularly to a driver management method, system, unit and program for managing a device driver of a device connected to a network.

2. Description of the Related Art

With the spread of networks in these years, various types of devices such as printers, facsimiles and scanners have come to conform to the networks and have many occasions of commonly used by plural users.

Where a device such as a printer is used from a terminal device such as a personal computer (hereinafter referred to as the PC), it is necessary to install a device driver corresponding to the device to be used into the terminal device, but the driver cannot be installed if a user does not know when the device has been disposed and become available. Therefore, a manager must notify each user the disposition of the device when it is disposed and information about the device.

Similarly, if the users do not know that the device driver was updated, the users cannot install the updated device driver. Therefore, the manager must notify the individual users that the device driver was updated.

There is a technology to facilitate such processing that, when a printer has a means for storing a printer driver therein and it is found by checking printer driver information attached to print data transmitted from a terminal device that a printer driver of a version older than the stored printer driver is being used, the stored printer driver is sent to the terminal device to update it (e.g., Japanese Patent Application Laid-Open No. 2001-296976).

There is also proposed a technology capable of installing a driver easily when an output device is directly connected (local-connected) to a terminal device (e.g., Japanese Patent Application Laid-Open No. 2003-114859).

But, the technology described in Japanese Patent Application Laid-Open No. 2001-296976 will increase a cost of the printer product because the printer must be provided with a means for storing the printer driver, a means for judging whether the printer driver is new or not, and a means for transmitting the printer driver. This cost increase has a large influence on the operation of the network when plural printers and other devices are disposed on the same network.

### SUMMARY OF THE INVENTION

The present invention has been made in view of the above circumstances and provides a driver management method, system, unit and program capable of managing a device driver to be installed in a terminal device without heavily burdening the manager and users.

An aspect of the present invention provides a driver management method for a driver management unit to manage a device driver to be installed in terminal devices which use a device connected to a network, comprising: monitoring a driver storage unit in which the device driver for using the device is stored, when the device driver stored in the driver storage unit is updated, specifying a terminal device into which the updated device driver is installed, and installing the updated device driver into the specified terminal device.

According to the present invention, the device driver to be installed into terminal devices can be updated without heavily burdening the manager and users.

### BRIEF DESCRIPTION OF THE DRAWINGS

Embodiments of the present invention will be described in detail based on the following figures, wherein:

FIG. 1 is a diagram showing a functional structure of a management unit and a connected structure example of a network according to Example 1;

FIG. 2 is a flow chart showing a flow of driver update processing in Example 1;

FIG. 3 is a diagram showing a functional structure of a management unit and a connected structure example of a network according to Example 2;

FIG. 4 is a flow chart showing a flow of driver update processing in Example 2;

FIG. 5 is a diagram showing a functional structure of a management unit and a connected structure example of a network according to Example 3;

FIG. 6 is a flow chart showing a flow of driver update processing in Example 3;

FIG. 7 is a diagram showing a functional structure of a management unit and a connected structure example of a network according to Example 4;

FIG. 8 is a flow chart showing a flow of driver update processing in Example 4;

FIG. 9 is a diagram showing a functional structure of a management unit and a connected structure example of a network according to Example 5;

FIG. 10 is a flow chart showing a flow of driver update processing in Example 5;

FIG. 11 is a diagram showing a functional structure of a management unit and a connected structure example of a network according to Example 6;

FIG. 12 is a flow chart showing a flow of driver update processing in Example 6;

FIG. 13 is a diagram showing a network structure of a driver management system and a functional structure of each device according to Example 7;

FIG. 14 is a flow chart showing a flow of driver install processing by an output device 1002 and a terminal device 1001;

FIG. 15 is a diagram showing a network structure of a driver management system and a functional structure of each device according to Example 8;

FIG. 16 is a flow chart showing a flow of driver install processing by an output device 1202 and a terminal device 1201;

FIG. 17 is a diagram showing a network structure of a driver management system and a functional structure of each device according to Example 9;

FIG. 18 is a flow chart showing a flow of driver install processing by an output device 1402 and a management unit 1404;

FIG. 19 is a diagram showing a network structure of a driver management system and a functional structure of each device according to Example 10; and

FIG. 20 is a flow chart showing a flow of driver install processing by a management unit 1604.

### DESCRIPTION OF THE EMBODIMENTS

Embodiments of a driver management method, system, unit and program according to the present invention will be described with reference to the accompanying figures.

Plural examples will be described below, and the structures described in the individual examples can be combined appropriately to practice the present invention unless especially described.

### EXAMPLE 1

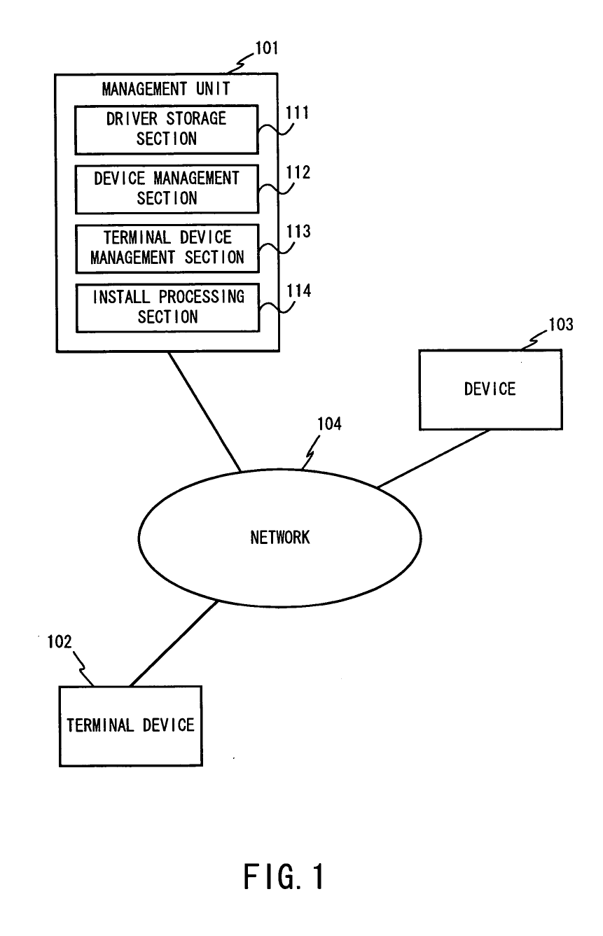

FIG. 1 is a diagram showing a functional structure of a management unit and a connected structure example of a network in Example 1. As shown in FIG. 1, a management unit 101 is connected to a terminal device 102 and a device 103 over a network 104.

The management unit 101 is realized by executing a program by a server computer or the like and manages a device driver of the device 103 which is installed in the terminal device 102.

The terminal device 102 is a PC (personal computer) or the like operating as a client, executes various types of application software and uses the device 103. In practice, plural terminal devices 102 are often connected to the network 104.

The device 103 is a device such as a printer, a facsimile, a scanner or the like usable through the network, and its use requires a device driver. The device 103 can be a conventionally used one, and plural devices 103 can also be connected to the network 104.

Here, the management unit 101 will be described in detail. As shown in FIG. 1, the management unit 101 is comprised of a driver storage section 111, a device management section 112, a terminal device management section 113 and an install processing section 114.

The driver storage section 111 stores a device driver of the device 103. The device driver is stored in the driver storage section 111 by a manager or the like. The device management section 112 manages the devices 103 which are connected to the network 104 and specifies to which of the devices 103 the device driver stored in the driver storage section 111 conforms. The terminal device management section 113 manages the terminal device 102 connected to the network 104 and specifies the terminal device 102, into which the device driver stored in the driver storage section 111 is to be installed, according to the device 103 specified by the device management section 112. The install processing section 114 installs the device driver stored in the driver storage section 111 into the terminal device 102 specified by the device management section 112.

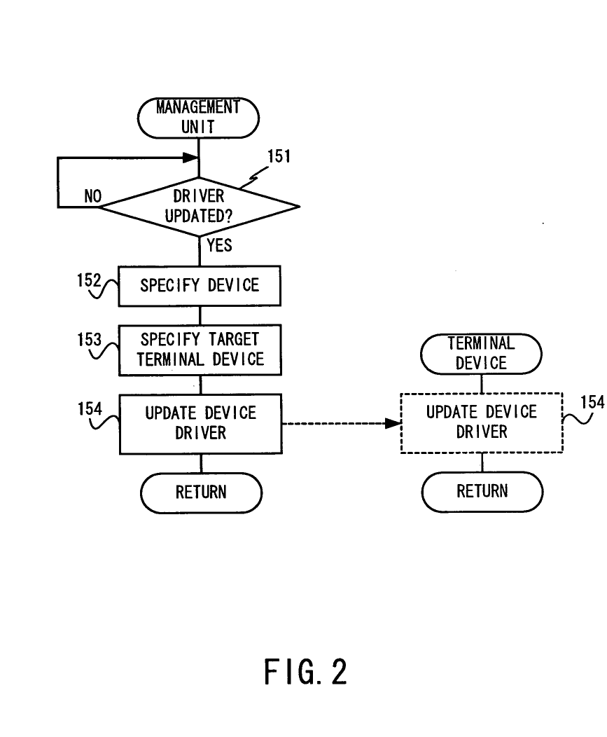

Then, driver update processing by the management unit 101 will be described. FIG. 2 is a flow chart showing a flow of the driver update processing in Example 1.

In the management unit 101, when the driver storage section 111 detects that the stored device driver is updated (YES in step 151), the device management section 112 specifies the device 103 corresponding to the updated device driver (step 152). Subsequently, the terminal device management section 113 specifies the terminal device 102 which uses the specified device 103 (step 153), and the install processing section 114 installs the updated device driver into the specified terminal device 102 (step 154) and terminates the driver update processing.

When the device 103 is newly disposed, it is also possible to newly install a device driver by the management unit 101 by making the device management section 112 manage information about the device 103 to be disposed, making the terminal device management section 113 manage information about the terminal device 102 which allows the use of the device 103 to be disposed, and storing the device driver of the device 103 to be disposed into the driver storage section 111.

### EXAMPLE 2

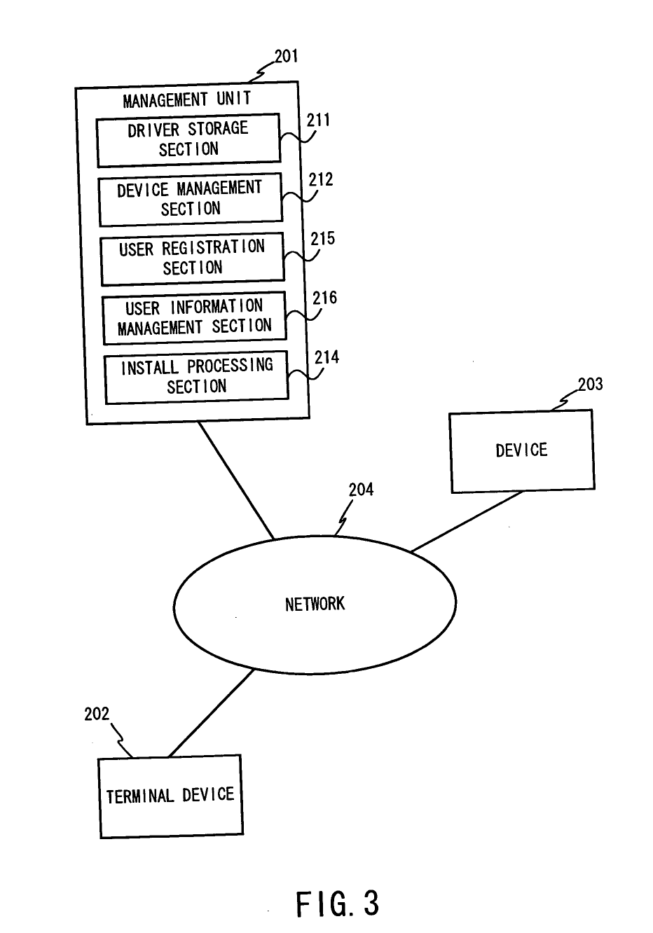

FIG. 3 is a diagram showing a functional structure of a management unit and a connected structure example of a network according to Example 2. As shown in FIG. 3, a management unit 201 is connected to a terminal device 202 and a device 203 over a network 204.

The management unit 201 is realized by executing a program by a server computer or the like and manages a device driver of the device 203 which is installed in the terminal device 202.

The terminal device 202 is a PC (personal computer) or the like operating as a client, executes various types of application software and uses the device 203. In practice, plural terminal devices 202 are often connected to the network 204.

The device 203 is a device such as a printer, a facsimile, a scanner or the like usable through the network, and its use requires a device driver. The device 203 can be a conventionally used one, and plural devices 203 can also be connected to the network 204.

Here, the management unit 201 will be described in detail. As shown in FIG. 3, the management unit 201 is comprised of a driver storage section 211, a device management section 212, a user registration section 215, a user information management section 216 and an install processing section 214.

The driver storage section 211 stores a device driver of the device 203. The device driver is stored in the driver storage section 211 by a manager or the like. The device management section 212 manages the devices 203 connected to the network 204 and specifies to which of the devices 203 the device driver stored in the driver storage section 211 conforms. The user registration section 215 accepts registration of a user, who uses the device 203, by the manager or the like. At the time of registration of the user, user information including information capable of specifying at least the terminal device 202 used by the user and the device 203 which can be used from the terminal device 202 is accepted. The user information management section 216 manages the user information accepted by the user registration section 215, specifies a user who uses the device 203 specified by the device management section 212 and specifies the terminal device 202 into which the device driver stored in the driver storage section 211 is installed. The install processing section 214 installs the device driver stored in the driver storage section 211 into the terminal device 202 specified by the user registration section 215.

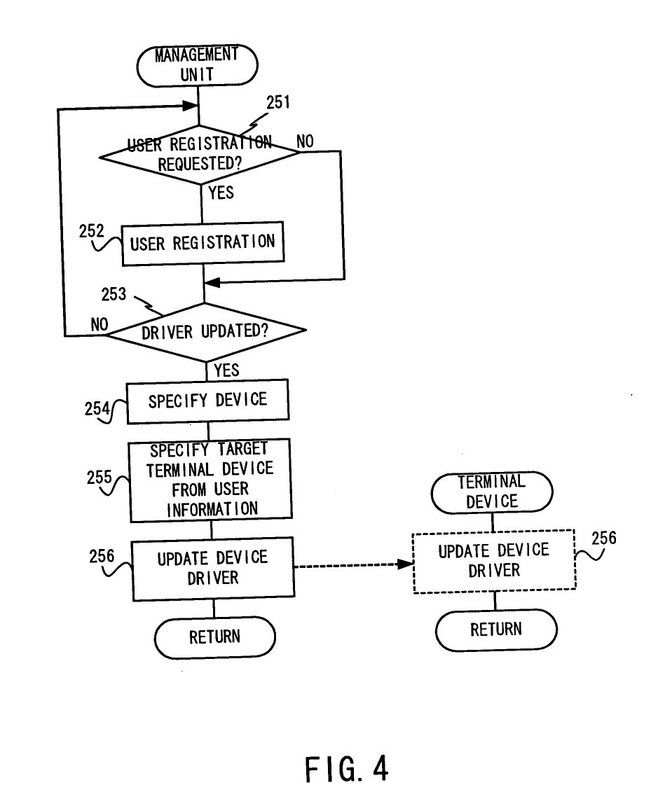

Then, driver update processing by the management unit 201 will be described. FIG. 4 is a flow chart showing a flow of the driver update processing in Example 2.

When the management unit 201 has a user registration request from the manager or the like (YES in step 251), the user registration section 215 accepts user information about the user to be registered, and the user information management section 216 manages the accepted user information (step 252).

In the management unit 201, when the driver storage section 211 detects that the stored device driver is updated (YES in step 253), the device management section 212 specifies the device 203 corresponding to the updated device driver (step 254). Subsequently, the user information management section 216 specifies the user who uses the specified device 203 and specifies the terminal device 202 to be used by the user (step 255). And, the install processing section 214 installs the updated device driver into the specified terminal device 202 (step 256) and terminates the driver update processing.

When the device 203 is newly disposed, it is also possible to newly install a device driver by the management unit 201 by making the device management section 212 manage information about the device 203 to be disposed, registering user information about the user to be allowed to use the device 203 to be disposed from the user registration section 215, and storing the device driver of the device 203 to be disposed into the driver storage section 211.

### EXAMPLE 3

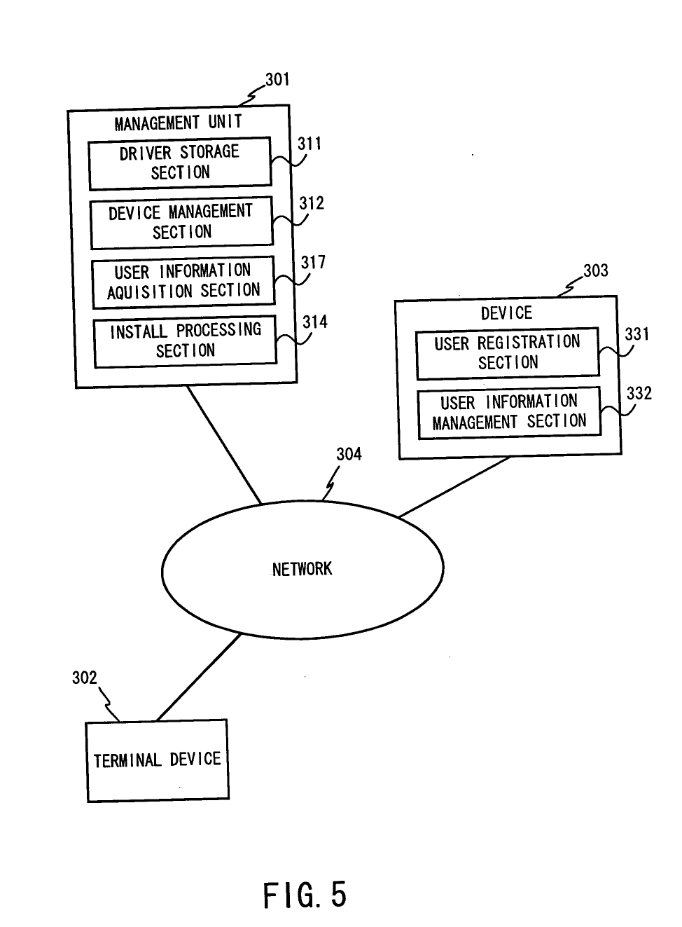

FIG. 5 is a diagram showing a functional structure of a management unit and a connected structure example of a network according to Example 3. As shown in FIG. 5, a management unit 301 is connected to a terminal device 302 and a device 303 over a network 304.

The management unit 301 is realized by executing a program by a server computer or the like and manages a device driver of the device 303 which is installed in the terminal device 302.

The terminal device 302 is a PC (personal computer) or the like operating as a client, executes various types of application software and uses the device 303. In practice, plural terminal devices 302 are often connected to the network 304.

The device 303 is a device such as a printer, a facsimile, a scanner or the like usable through the network, and its use requires a device driver. And, the device 303 is provided with a user registration section 331 and a user information management section 332. The user registration section 331 accepts the registration of a user, who uses the device 303, by the manager or the like and accepts at least user information containing information which can specify the terminal device 302 to be used by the user. The user information management section 332 manages the user information accepted by the user registration section 331. This device 303 can be a conventionally used one if it can manage the user information, and plural devices 303 can also be connected to the network 304.

Here, the management unit 301 will be described in detail. As shown in FIG. 5, the management unit 301 is comprised of a driver storage section 311, a device management section 312, a user information acquisition section 317, and an install processing section 314.

The driver storage section 311 stores a device driver of the device 303. The device driver is stored in the driver storage section 311 by a manager or the like. The device management section 312 manages the devices 303 connected to the network 304 and specifies to which of the devices 303 the device driver stored in the driver storage section 311 conforms. The user information acquisition section 317 obtains the user information registered in the device 303 from the device 303 specified by the device management section 312 and specifies the terminal device 302 to be used by the user who uses the device 303. The install processing section 314 installs the device driver stored in the driver storage section 311 into the terminal device 302 specified by the user information acquisition section 317.

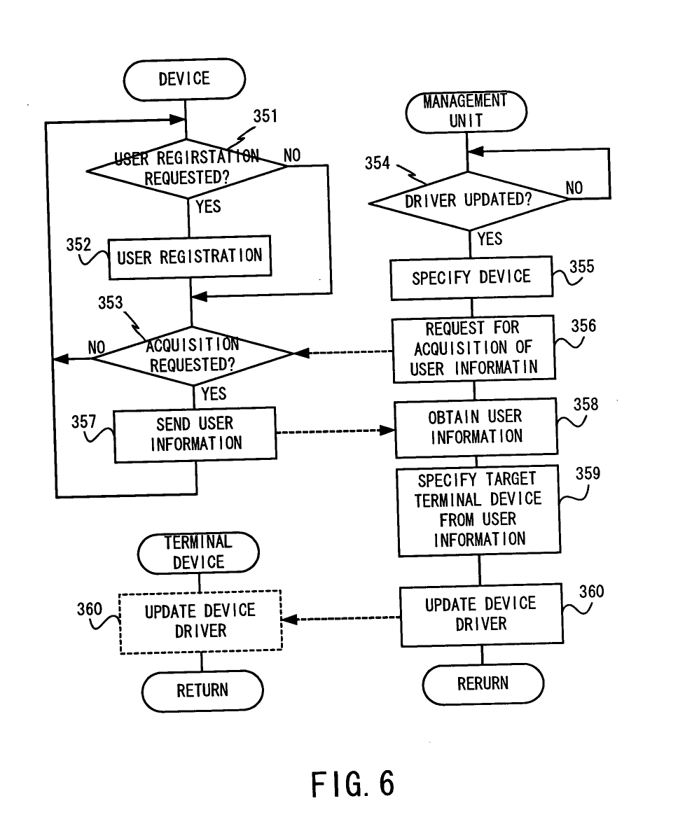

Then, driver update processing by the management unit 301 will be described. FIG. 6 is a flow chart showing a flow of the driver update processing in Example 3.

First, when the device 303 has a user registration request from the manager or the like (YES in step 351), the user registration section 331 accepts user information about the user to be registered, and the user information management section 332 manages the accepted user information (step 352). And, the device 303 falls in a standby state until there is another user registration request or a user information acquisition request (NO in step 353, NO in step 351).

Meanwhile, in the management unit 301, when the driver storage section 311 detects that the stored device driver is updated (YES in step 354), the device management section 312 specifies the device 303 corresponding to the updated device driver (step 355). Subsequently, the user information acquisition section 317 requests the specified device 303 to obtain user information (step 356), the user information management section 332 of the device 303 responds to the request (YES in step 353) and sends the user information (step 357), and the user information acquisition section 317 obtains the user information (step 358).

And, when the user information acquisition section 317 specifies the terminal device 302 used by the user according to the obtained user information (step 359), the install processing section 314 installs the updated device driver into the specified terminal device 302 (step 360) and terminates the driver update processing.

When the device 303 is newly disposed, it is also possible to newly install the device driver by the management unit 301 by making the device management section 312 manage information about the device 303 to be disposed, registering user information about the user to be allowed to use the device 303 to be disposed from the user registration section 331, and storing the device driver of the device 303 to be disposed into the driver storage section 311.

### EXAMPLE 4

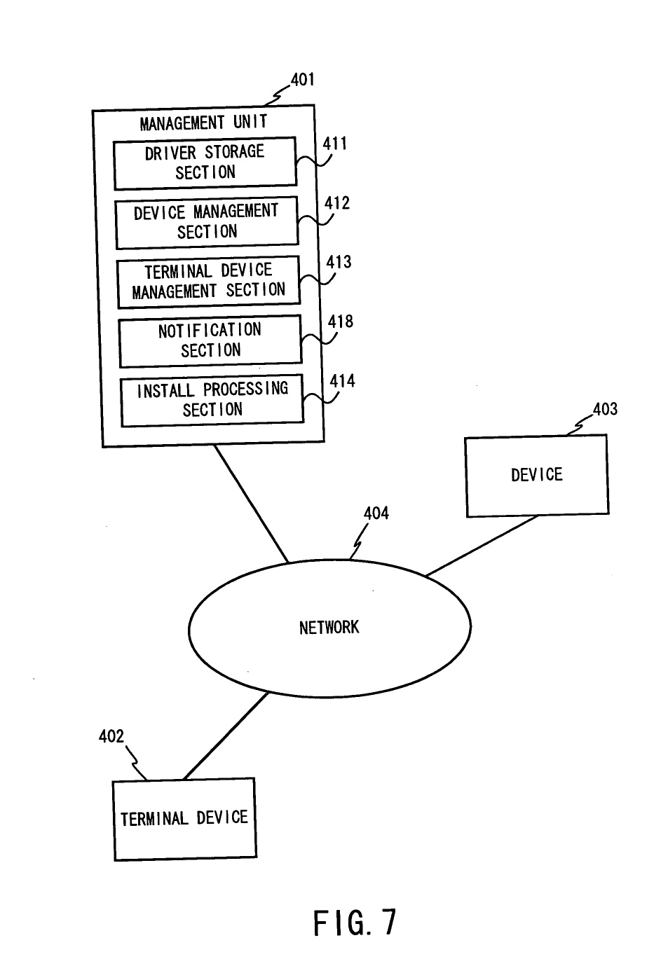

FIG. 7 is a diagram showing a functional structure of a management unit and a connected structure example of a network according to Example 4. As shown in FIG. 7, a management unit 401 is connected to a terminal device 402 and a device 403 over a network 404.

The management unit 401 is realized by executing a program by a server computer or the like and manages a device driver of the device 403 which is installed in the terminal device 402.

The terminal device 402 is a PC (personal computer) or the like operating as a client, executes various types of application software and uses the device 403. In practice, plural terminal devices 402 are often connected to the network 404.

The device 403 is a device such as a printer, a facsimile, a scanner or the like usable through the network, and its use requires a device driver. And, the device 403 can be a conventionally used one, and plural devices 404 can be connected to the network 404.

Here, the management unit 401 will be described in detail. As shown in FIG. 7, the management unit 401 is comprised of a driver storage section 411, a device management section 412, a terminal device management section 413, a notification section 418 and an install processing section 414.

The driver storage section 411 stores a device driver of the device 403. The device driver is stored in the driver storage section 411 by a manager or the like. The device management section 412 manages the devices 403 connected to the network 404 and specifies to which of the devices 403 the device driver stored in the driver storage section 411 conforms. The terminal device management section 413 manages the terminal device 402 connected to the network 404 and specifies the terminal device 402 to which the device driver stored in the driver storage section 411 is installed according to the device 403 specified by the device management section 412. The notification section 418 notifies the terminal device 402 specified by the terminal device management section 413 that the driver is updated. The install processing section 414 installs the updated device driver into the terminal device 402, of which update is approved by the user, among the terminal devices 402 specified by the device management section 412.

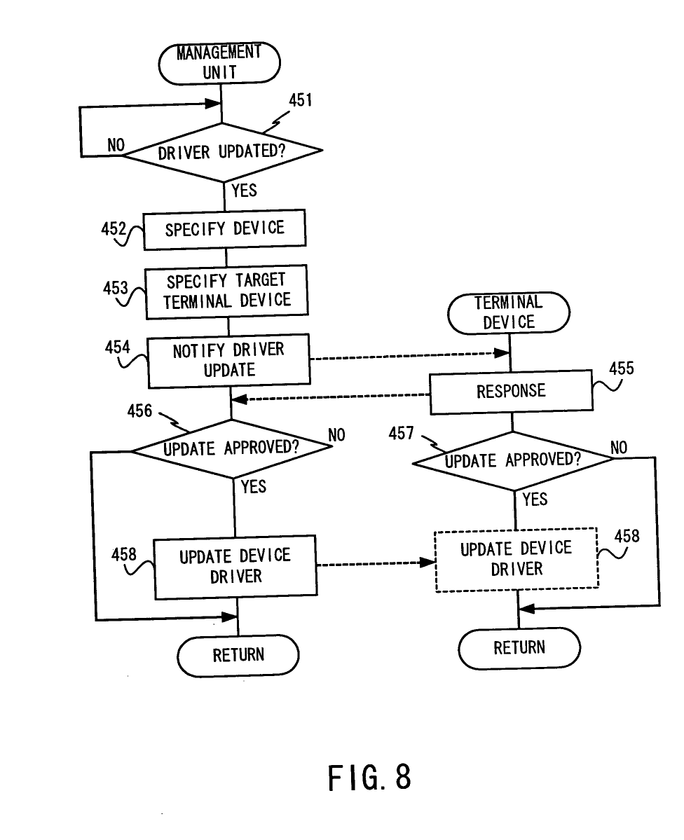

Then, driver update processing by the management unit 401 will be described. FIG. 8 is a flow chart showing a flow of driver update processing in Example 4.

In the management unit 401, when the driver storage section 411 detects that the stored device driver is updated (YES in step 451), the device management section 412 specifies the device 403 corresponding to the updated device driver (step 452). Subsequently, the terminal device management section 413 specifies the terminal device 402 which uses the specified device 403 (step 453), and the notification section 418 notifies the specified terminal device 402 that the device driver is updated and asks whether the install of the updated device driver is approved (step 454).

The terminal device 402 responds to the notice from the notification section 418 (step 455), and when the response is an approval of the update of the device driver (YES in step 456, YES in step 457), the install processing section 414 installs the updated device driver into the terminal device 402 (step 458) and terminates the driver update processing.

And, when the response of the terminal device 402 to the notice from the notification section 418 denies the update of the device driver (NO in step 456, NO in step 457), the driver update processing is terminated without installing the device driver. If there is not a response from the terminal device 402 to the notice from the notification section 418 for a prescribed time, it is determined that the terminal device 402 has denied the update of the device driver, and the processing is continued.

When the device 403 is newly disposed, it is also possible to newly install the device driver by the management unit 401 by making the device management section 412 manage information about the device 403 to be disposed, making the terminal device management section 413 manage the information of the terminal device 402 which allows the use of the device 403 to be disposed, and storing the device driver of the device 403 to be disposed into the driver storage section 411.

### EXAMPLE 5

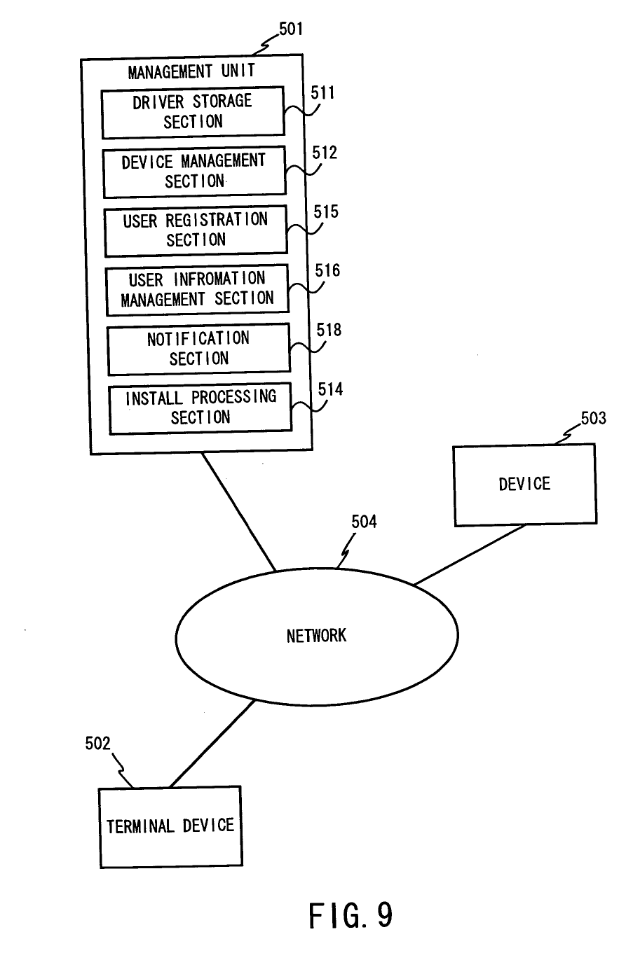

FIG. 9 is a diagram showing a functional structure of a management unit and a connected structure example of a network according to Example 5. As shown in FIG. 9, a management unit 501 is connected to a terminal device 502 and a device 503 over a network 504.

The management unit 501 is realized by executing a program by a server computer or the like and manages a device driver of the device 503 which is installed in the terminal device 502.

The terminal device 502 is a PC (personal computer) or the like operating as a client, executes various types of application software and uses the device 503. In practice, plural terminal devices 502 are often connected to the network 504.

The device 503 is a device such as a printer, a facsimile, a scanner or the like usable through the network, and its use requires a device driver. And, the device 503 can be a conventionally used one, and plural devices 503 can be connected to the network 504.

Here, the management unit 501 will be described in detail. As shown in FIG. 9, the management unit 501 is comprised of a driver storage section 511, a device management section 512, a user registration section 515, a user information management section 516, a notification section 518 and an install processing section 514.

The driver storage section 511 stores a device driver of the device 503. The device driver is stored in the driver storage section 511 by a manager or the like. The device management section 512 manages the devices 503 connected to the network 504 and specifies to which of the devices 503 the device driver stored in the driver storage section 511 conforms. The user registration section 515 accepts registration of a user, who uses the device 503, by the manager or the like. At the time of registration of the user, user information including information capable of specifying at least the terminal device 502 used by the user and the device 503 which is used from the terminal device 502 is accepted. The user information management section 516 manages the user information accepted by the user registration section 515, specifies a user who uses the device 503 specified by the device management section 512 and specifies the terminal device 502 into which the device driver stored in the driver storage section 511 is installed. The notification section 518 notifies the terminal device 502 specified by the user information management section 516 that the driver is updated. The install processing section 514 installs the updated device driver into the terminal device 502, of which update is approved by the user, among the terminal devices 502 specified by the user information management section 516.

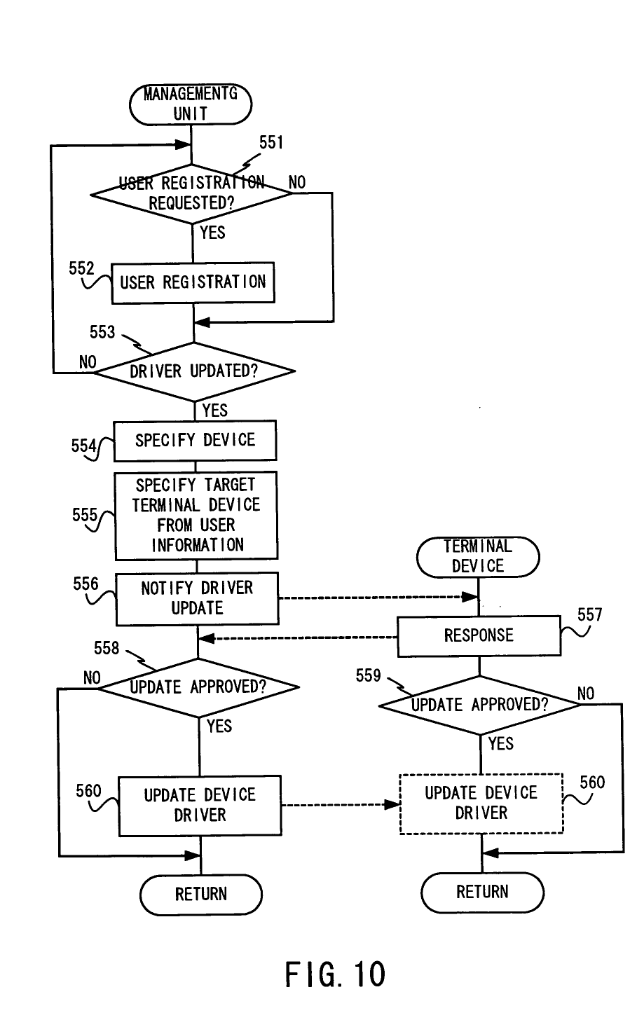

Then, driver update processing by the management unit 501 will be described. FIG. 10 is a flow chart showing a flow of driver update processing according to Example 5.

When the management unit 501 has a user registration request from the manager or the like (YES in step 551), the user registration section 515 accepts user information about the user to be registered, and the user information management section 516 manages the accepted user information (step 552).

In the management unit 501, when the driver storage section 511 detects that the stored device driver is updated (YES in step 553), the device management section 512 specifies the device 503 corresponding to the updated device driver (step 554). Subsequently, the user information management section 516 specifies the user who uses the specified device 503 and specifies the terminal device 502 to be used by the user (step 555). Then, the notification section 518 notifies the specified terminal device 502 that the device driver is updated and asks whether the install of the updated device driver is approved (step 556).

When the terminal device 502 responds to the notice from the notification section 518 (step 557) and the response is an approval of the update of the device driver (YES in step 558, YES in step 559), the install processing section 514 installs the updated device driver into the terminal device 502 (step 560) and terminates the driver update processing.

When the response by the terminal device 502 to the notice from the notification section 518 denies the update of the device driver (NO in step 558, NO in step 559), the driver update processing is terminated without installing the device driver. If there is not a response from the terminal device 502 to the notice from the notification section 518 for a prescribed time, it is determined that the terminal device 502 has denied the update of the device driver, and the processing is continued.

When the device 503 is newly disposed, it is also possible to newly install the device driver by the management unit 501 by making the device management section 512 manage information about the device 503 to be disposed, registering user information about the user to be allowed to use the device 503 to be disposed from the user registration section 515, and storing the device driver of the device 503 to be disposed into the driver storage section 511.

### EXAMPLE 6

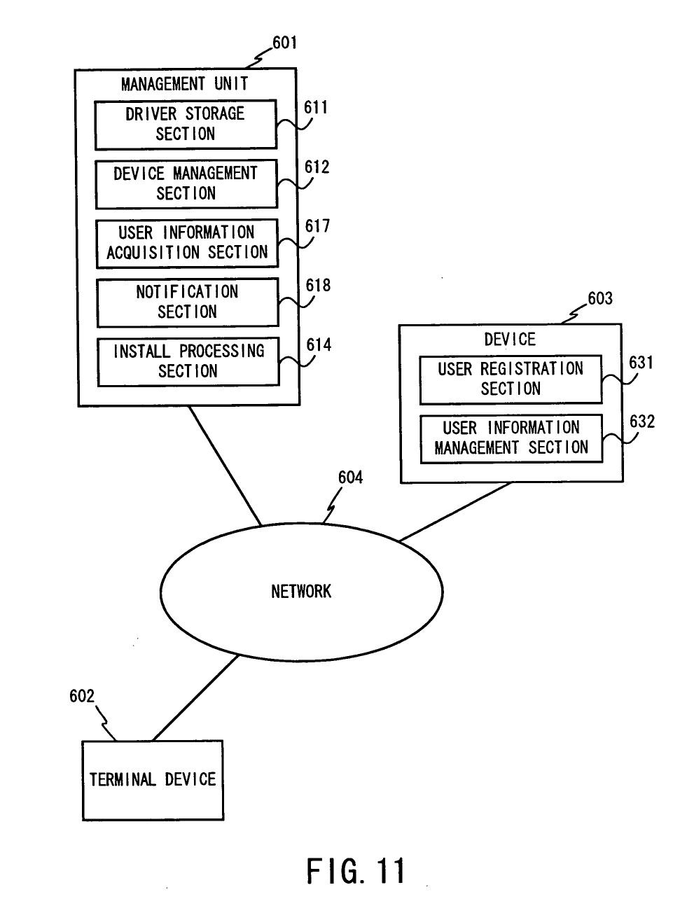

FIG. 11 is a diagram showing a functional structure of a management unit and a connected structure example of a network according to Example 6. As shown in FIG. 11, a management unit 601 is connected to a terminal device 602 and a device 603 over a network 604.

The management unit 601 is realized by executing a program by a server computer or the like and manages a device driver of the device 603 which is installed in the terminal device 602.

The terminal device 602 is a PC (personal computer) or the like operating as a client, executes various types of application software and uses the device 603. In practice, plural terminal devices 602 are often connected to the network 604.

The device 603 is a device such as a printer, a facsimile, a scanner or the like usable through the network, and its use requires a device driver. And, the device 603 is provided with a user registration section 631 and a user information management section 632. The user registration section 631 accepts the registration of a user, who uses the device 603, by the manager or the like and accepts at least user information containing information which can specify the terminal device 602 to be used by the user. The user information management section 632 manages the user information received by the user registration section 631. This device 603 can be a conventionally used one if it can manage the user information, and plural devices 603 can also be connected to the network 604.

Here, the management unit 601 will be described in detail. As shown in FIG. 11, the management unit 601 is comprised of a driver storage section 611, a device management section 612, a user information acquisition section 617, a notification section 618 and an install processing section 614.

The driver storage section 611 stores a device driver of the device 603. The device driver is stored in the driver storage section 611 by a manager or the like. The device management section 612 manages the devices 603 connected to the network 604 and specifies to which of the devices 603 the device driver stored in the driver storage section 611 conforms. The user information acquisition section 617 obtains the user information registered in the device 603 from the device 603 specified by the device management section 612 and specifies the terminal device 602 to be used by the user who uses the device 603. The notification section 618 notifies the terminal device 602 specified by the user information acquisition section 617 that the driver is updated. The install processing section 614 installs the updated device driver into the terminal device 602, of which update is approved by the user, among the terminal devices 402 specified by the device management section 612.

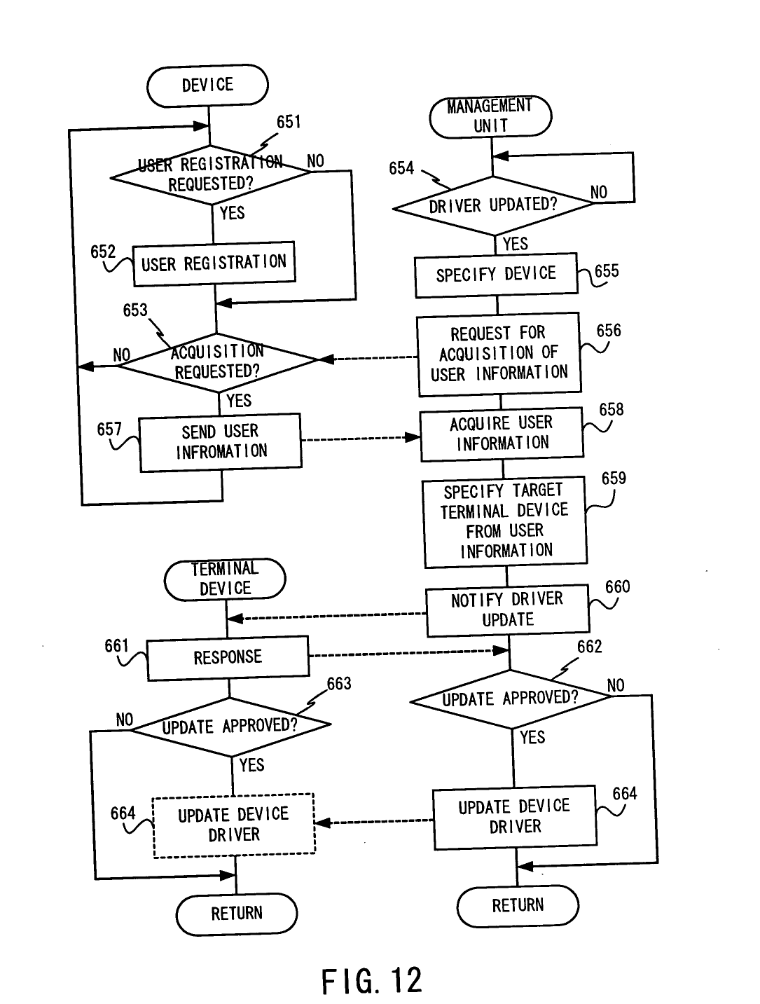

Then, driver update processing by the management unit 601 will be described. FIG. 12 is a flow chart showing a flow of driver update processing according to Example 6.

First, when the device 603 has a user registration request from the manager or the like (YES in step 651), the user registration section 631 accepts user information about the user to be registered, and the user information management section 632 manages the accepted user information (step 652). And, the device 603 falls in a standby state until there is another user registration request or a user information acquisition request (NO in step 653, No in step 651).

Meanwhile, in the management unit 601, when the driver storage section 611 detects that the stored device driver is updated (YES in step 654), the device management section 612 specifies the device 603 corresponding to the updated device driver (step 655). Subsequently, the user information acquisition section 617 requests the specified device 603 to obtain the user information (step 656), the user information management section 657 of the device 603 responds to the request (YES in step 653) and sends the user information (step 657), and the user information acquisition section 617 obtains the user information (step 658).

And, when the user information acquisition section 617 specifies the terminal device 602 used by the user according to the obtained user information (step 659), the notification section 618 notifies the specified terminal device 602 that the device driver is updated and asks whether the install of the updated device driver is approved (step 660).

The terminal device 602 responds to the notice from the notification section 618 (step 661), and when the response approves the update of the device driver (YES in step 662, YES in step 663), the install processing section 614 installs the updated device driver into the terminal device 602 (step 664) and terminates the driver update processing.

When the response by the terminal device 602 to the notice from the notification section 618 denies the update of the device driver (NO in step 662, NO in step 663), the driver update processing is terminated without installing the device driver. If there is not a response from the terminal device 602 to the notice from the notification section 618 for a prescribed time, it is determined that the terminal device 602 has denied the update of the device driver, and the processing is continued.

When the device 603 is newly disposed, it is also possible to newly install the device driver by the management unit 601 by making the device management section 612 manage information about the device 603 to be disposed, registering user information about the user to be allowed to use the device 603 to be disposed from the user registration section 631, and storing the device driver of the device 603 to be disposed into the driver storage section 611.

### EXAMPLE 7

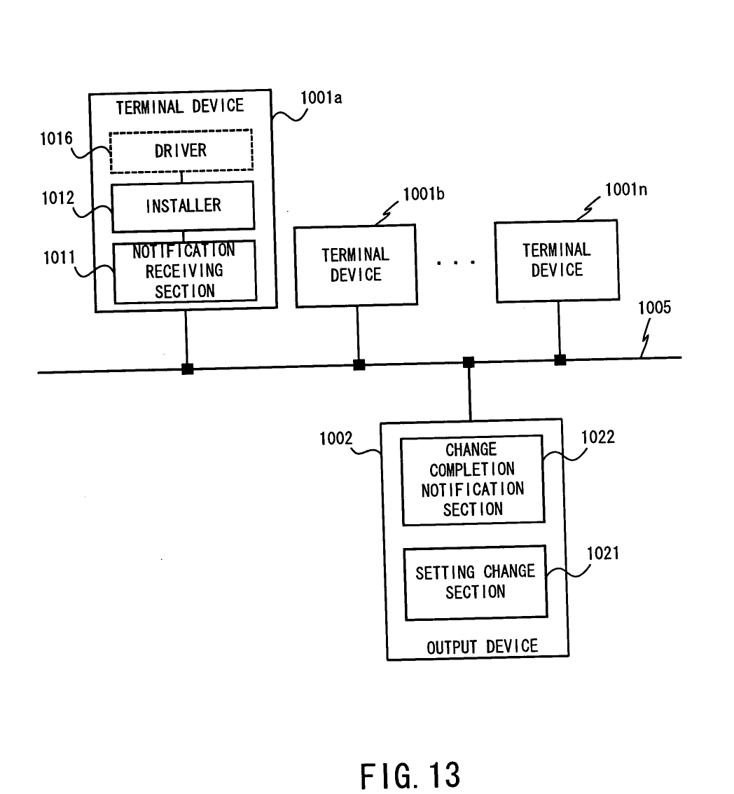

FIG. 13 is a diagram showing a network structure of a driver management system and a functional structure of each device according to Example 7.

As shown in FIG. 13, this driver management system has plural terminal devices 1001 (1001a to 1001n) and an output device 1002 connected over a network 1005.

The terminal devices 1001 are PCs or the like used by users, execute application software to perform various types of processing and use the output device 1002. The terminal devices 1001 each are provided with a notice receiving section 1011 and an installer 1012, and when the install processing to be described later is completed, the driver 1016 for using the output device 1002 falls in an installed state. In FIG. 13, the notice receiving section 1011 and the like are omitted from the terminal device 1001b and the like, but the terminal devices 1001b to 100n each are also provided with the notice receiving section 1011 and the like in the same manner as the terminal device 1001a.

The notice receiving section 1011 receives a setting change notice to be described later from the output device 1002. The installer 1012 operates when the notice receiving section 1011 receives the setting change notice to install the driver 1016 into the terminal device 1001.

And, when the driver to be installed is not present in the terminal device 1001, the installer 1012 obtains a driver from an unshown server connected to the network 1005 or a server on another network connected over the network 105 and performs the install processing. The notice receiving section 1011 and the installer 1012 are configured by executing a program by the terminal device 1001.

The output device 1002 is an output device such as a printer, a facsimile, or the like and executes a job accepted through the network 1005. The output device 1002 is provided with a setting change section 1021 and a change completion notification section 1022.

The setting change section 1021 newly makes settings or makes a change of various settings such as a network address, an option, a program to be used and the like of the output device 1002. A setting screen is shown on an unshown display section to accept a change of setting, or a change of setting is made according to setting information transmitted by the manager via the network 1005. The setting change section 1021 is the same as that used for a conventional output device.

The change completion notification section 1022 detects a change of setting made by the setting change section 1021, and sends a setting change notice containing setting information such as the network address, an option and the like of the terminal device 1001. The detection of the setting change by the setting change section 1021 is performed by, for example, a method of detecting that the setting screen shown on the unshown display screen is closed. And, the setting change notice may be made by using a broadcast of the network 1005 or each notice may be made by obtaining each address of the terminal devices 1001 which is previously registered so to be notified. The notice receiving section 1011 receives a setting change notice transmitted by the change completion notification section 1022.

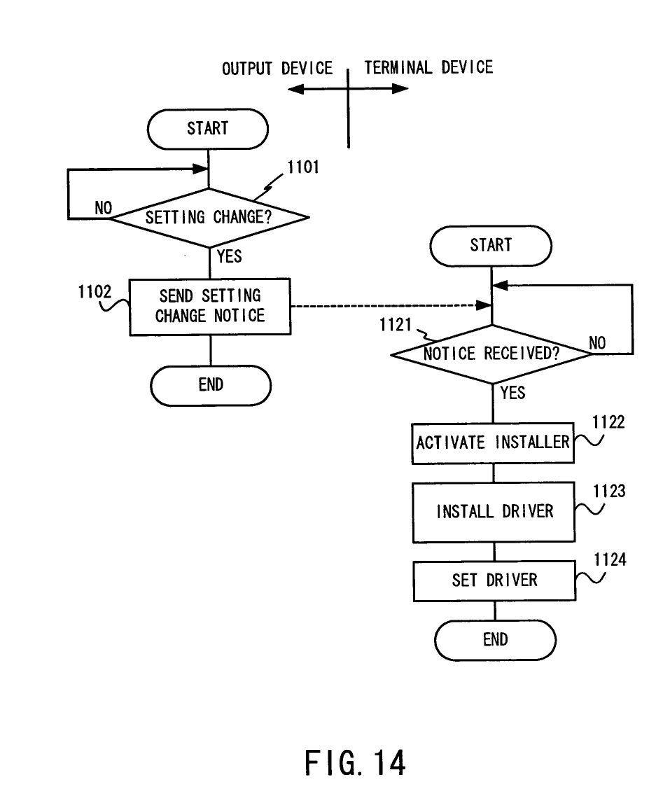

Then, a flow of driver install processing by the driver management system shown in FIG. 13 will be described. FIG. 14 is a flow chart showing a flow of driver install processing by the output device 1002 and the terminal device 1001.

In this processing, when the setting change section 1021 first changes the setting of the output device 1002 (YES in step 1101), the change completion notification section 1022 detects it and transmits a setting change notice containing setting information to the terminal device 1001 (step 1102). Thus, the processing by the output device 1002 is completed.

Meanwhile, in the terminal device 1001, when the notice receiving section 1011 receives the setting change notice (YES in step 1121), the notice receiving section 1011 activates the installer 1012 (step 1122). When the installer 1012 is activated, it installs the driver of the output device 1002 into the terminal device 1001 which is operated by the installer 1012 (step 1123), sets information necessary for the installed driver according to the setting information contained in the setting change notice (step 1124) and terminates the processing.

### EXAMPLE 8

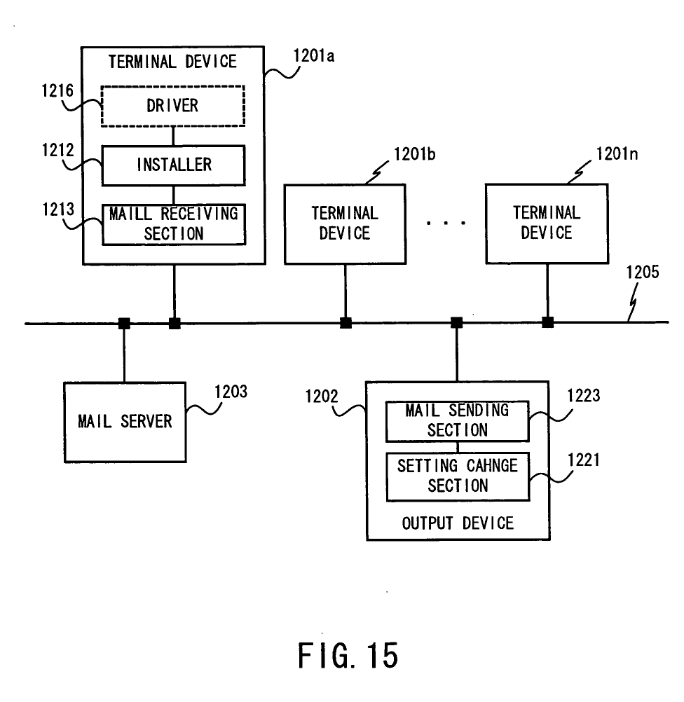

FIG. 15 is a diagram showing a network structure of a driver management system and a functional structure of each device according to Example 8.

As shown in FIG. 15, the driver management system has plural terminal devices 1201 (1201a to 1201n), an output device 1202 and a mail server 1203 connected over a network 1205.

The terminal device 1201 is a PC or the like used by a user, operates application software to execute various types of processing and uses the output device 1202. The terminal devices 1201 each are provided with a mail receiving section 1213 and an installer 1212, and a driver 1216 for using the output device 1202 falls in an installed state at the time when the install processing to be described later is completed. In FIG. 15, the mail receiving section 1213 and the like are omitted from the terminal device 1201b and the like, but the terminal devices 1201b to 1201n each are provided with the mail receiving section 1213 and the like in the same manner as the terminal device 1201a.

The mail receiving section 1213 receives an electronic mail from the mail server 1203 and basically operates in the same way as a general-purpose mailer but is different from the general-purpose mailer when a setting change notice to be described later is contained, and the installer 1212 is activated.

When the mail receiving section 1213 receives the setting change notice, the installer 1212 operates and installs the driver 1216 into the terminal device 1201. When the driver to be installed is not present in the terminal device 1201, the installer 1212 obtains a driver from an unshown server connected to the network 1205 or a server on another network connected over the network 1205 and performs the install processing. The notice receiving section 1213 and the installer 1212 are configured by executing a program by the terminal device 1201.

The output device 1202 is an output device such as a printer, a facsimile or the like and executes a job accepted through the network 1205. This output device 1202 is provided with a setting change section 1221 and a mail sending section 1223.

The setting change section 1221 newly makes settings or changes various types of settings such as a network address, an option, a used program and the like of the output device 1202, accepts a change of setting with a setting screen shown on an unshown display section, and changes the setting according to setting information transmitted by the manager over the network 1205. The setting change section 1221 is the same as that used for a conventional output device.

The mail sending section 1223 detects a change of setting by the setting change section 1221, and transmits an electronic mail including a setting change notice containing setting information such as a network address, an option or the like to the mail server 1203. The change of setting made by the setting change section 1221 is detected by, for example, a method of detecting that the setting screen shown on the unshown display screen is closed. The electronic mail containing the setting change notice may be transmitted separately by obtaining a mail address of each user who is previously registered so to be notified, and may be transmitted to a mail address for using an application for electronic mail such as a mailing list. The electronic mail sent by the mail sending section 1223 is then received by the mail receiving section 1213.

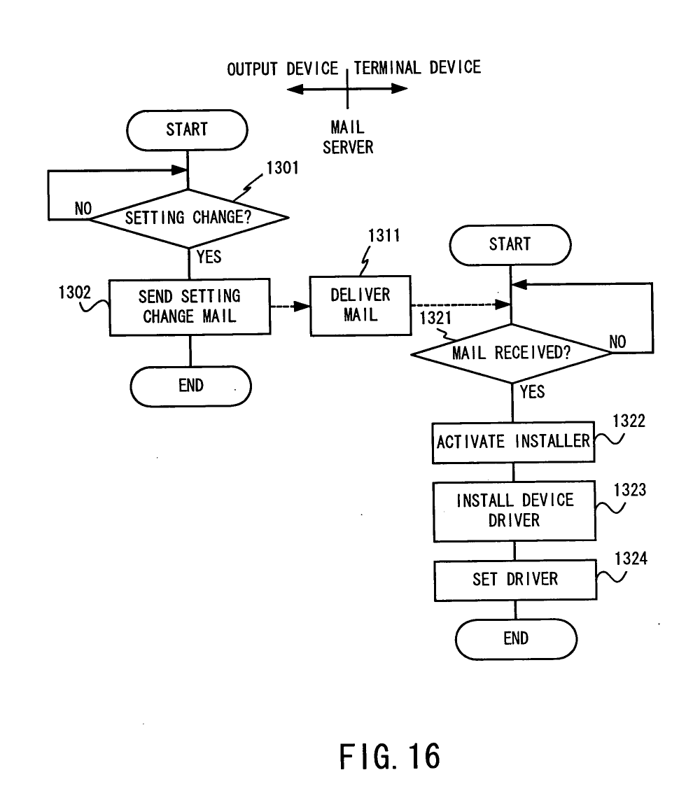

Then, a flow of driver install processing by the driver management system shown in FIG. 15 will be described. FIG. 16 is a flow chart showing a flow of driver install processing by the output device 1202 and the terminal device 1201.

In this processing, when the setting change section 1221 changes the setting of the output device 1202 (YES in step 1301), the mail sending section 1223 detects the change, prepares an electronic mail containing setting information, and sends the prepared electronic mail to the mail server 1203 (step 1302). Thus, the processing by the output device 1202 is terminated.

The electronic mail sent by the mail sending section 1223 is delivered by the mail server 1203 and stored in a receive box or the like of the designated user (step 1311).

Meanwhile, in the terminal device 1201, the mail receiving section 1213 receives the electronic mail containing the setting change notice (YES in step 1321) and activates the installer 1212 (step 1322). The activated installer 1212 installs the driver of the output device 1202 into the terminal device 1201 which is operated by the installer 1212 (step 1323), sets information necessary for the installed driver according to the setting information contained in the setting change notice (step 1324) and terminates the processing.

According to the structure of Example 8, the setting change notice by electronic mail can be received after activating even if the terminal device 1201 is not activated when the setting of the output device 1202 is changed.

### EXAMPLE 9

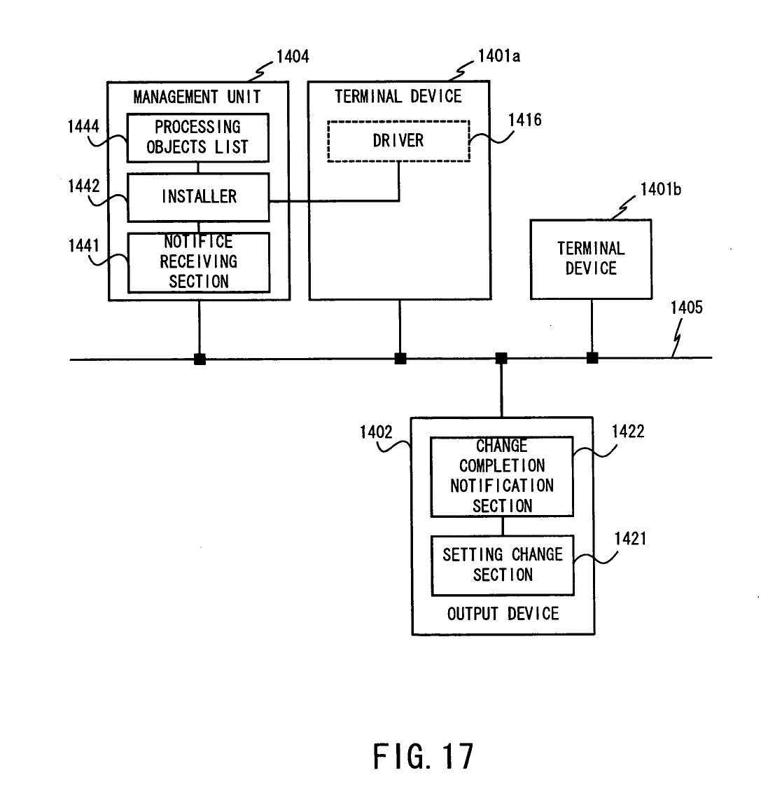

FIG. 17 is a diagram showing a network structure of a driver management system and a functional structure of each device according to Example 9.

As shown in FIG. 17, the driver management system has plural terminal devices 1401 (1401a, 1401b), an output device 1402 and a management unit 1404 connected over a network 1405.

The terminal devices 1401 are PCs or the like used by users, operate application software to execute various types of processing and use the output device 1402. The terminal devices 1401 each fall in a state that a driver 1416 for using the output device 1402 is installed at a stage that install processing to be described later is completed.

The output device 1402 is an output device such as a printer, a facsimile or the like and executes a job accepted over the network 1405. This output device 1402 is provided with a setting change section 1421 and a change completion notification section 1422.

The setting change section 1421 newly makes settings or changes various types of settings of a network address, an option, a used program and the like to the output device 1402, accepts a change of setting with a setting screen shown on an unshown display section, and changes the setting according to setting information transmitted by the manager over the network 1405. The setting change section 1421 is the same as that used for a conventional output device.

The change completion notification section 1422 detects a change of setting made by the setting change section 1421 and transmits a setting change notice containing setting information such as a network address, an option and the like to the management unit 1404. The change of setting by the setting change section 1421 is detected by, for example, a method of detecting that the setting screen shown on the unshown display screen is closed.

The management unit 1404 is a PC or the like used by the manager and manages the output device 1402 and the like. The management unit 1404 is provided with a notice receiving section 1441, an installer 1442 and a processing objects list 1444.

The notice receiving section 1441 receives a setting change notice from the output device 1402. The installer 1442 operates when the notice receiving section 1441 receives the setting change notice and installs the driver 1416 into the terminal device 1401. The processing objects list 1444 manages the terminal device 1401 which is subject to the install processing by the installer 1442.

When the driver to be installed is not present in the management unit 1404, the installer 1442 obtains a driver from an unshown server connected to the network 1405 or a server on another network connected over the network 1405 to perform the install processing. The notice receiving section 1441 and the installer 1442 are configured by executing a program by the management unit 1404.

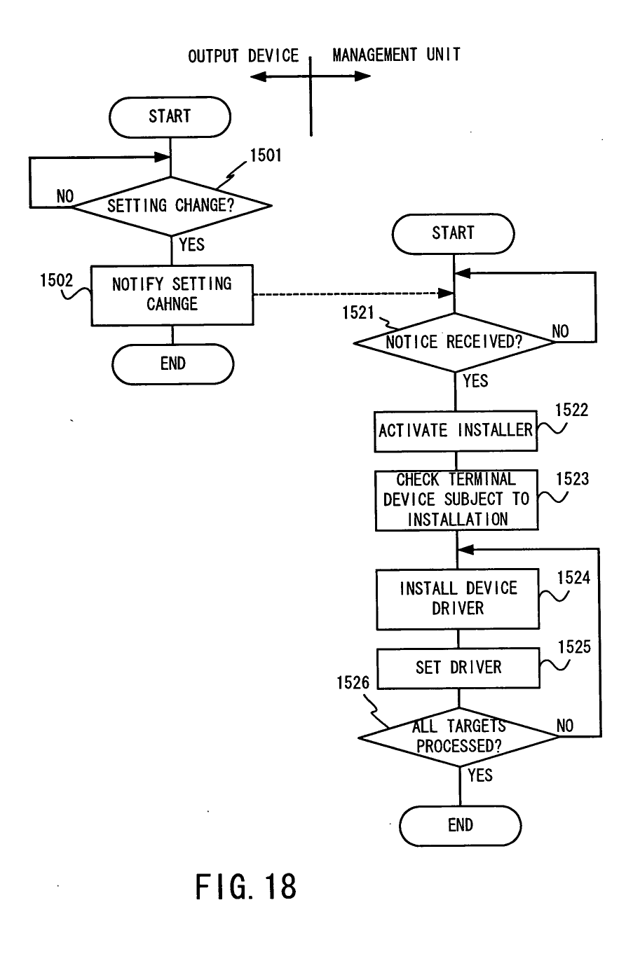

Then, a flow of the driver install processing by the driver management system shown in FIG. 17 will be described. FIG. 18 is a flow chart showing a flow of the driver install processing by the output device 1402 and the management unit 1404.

According to this processing, the setting change section 1421 changes the setting of the output device 1402 (YES in step 1501), and the change completion notification section 1422 detects the change and sends a setting change notice containing setting information to the terminal device 1401 (step 1502). Thus, the processing by the output device 1402 is terminated.

Meanwhile, in the management unit 1404, the notice receiving section 1441 receives the setting change notice (YES in step 1521) and activates the installer 1442 (step 1522). The activated installer 1442 refers to the processing objects list 1444 to check the terminal device 1401 in which the driver is installed (step 1523). And the installer 1442 installs the driver of the output device 1402 into the previously checked terminal device 1401 (step 1524) and sets information necessary for the installed driver according to the setting information contained in the setting change notice (step 1525). And, the installer installs the driver in and makes setting of all terminal devices 1401 under processing (NO in step 1526), and when the driver install into and setting of all the terminal devices 1401 under processing are completed (YES in step 1526), the processing is terminated.

### EXAMPLE 10

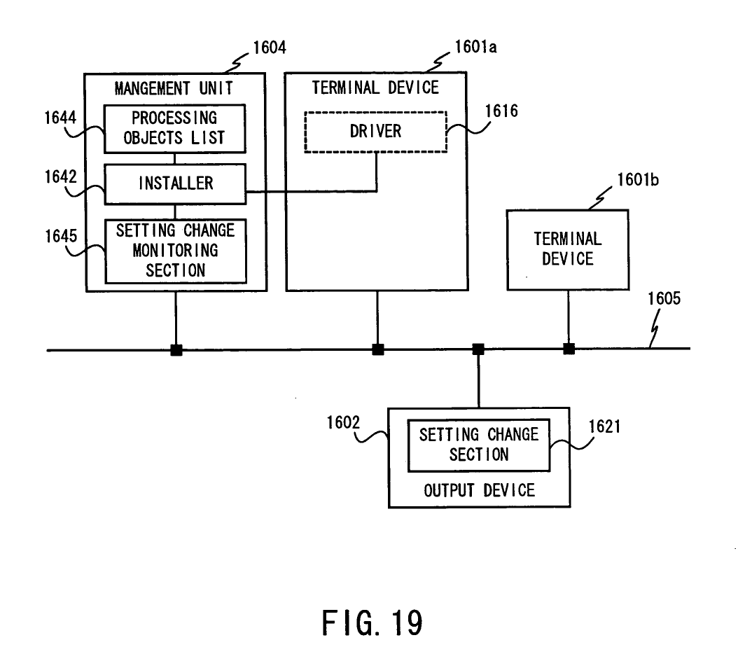

FIG. 19 is a diagram showing a network structure of a driver management system and a functional structure of each device according to Example 10.

As shown in FIG. 19, the driver management system has plural terminal devices 1601 (1601a, 1601b), an output device 1602 and a management unit 1604 connected over a network 1605.

The terminal devices 1601 are PCs or the like used by users, operate application software to execute various types of processing and use the output device 1602. The terminal device 1601 falls in a state that a driver 1616 for using the output device 1602 is installed at a stage that install processing to be described later is completed.

The output device 1602 is an output device such as a printer, a facsimile or the like and executes a job received over the network 1605. This output device 1602 is provided with a setting change section 1621.

The setting change section 1621 newly makes settings or changes various types of settings such as a network address, an option, a used program and the like of the output device 1602, accepts a change of setting with a setting screen shown on an unshown display section, and changes the setting according to setting information transmitted by the manager over the network 1605. The setting change section 1621 is the same as that used for a conventional output device.

The management unit 1604 is a PC or the like used by the manager and manages the output device 1602 and the like. The management unit 1604 is provided with a setting change monitoring section 1645, an installer 1642 and a processing objects list 1644.

The setting change monitoring section 1645 monitors the output device 1602 to detect that the setting of the output device 1602 is changed. The setting change is detected by, for example, periodically checking the setting of the output device 1602. When the setting change monitoring section 1645 detects the setting change, the installer 1642 operates and installs the driver 1616 into the terminal device 1601. The processing objects list 1644 manages the terminal device 1601 on which install processing is executed by the installer 1642.

When the driver to be installed is not present in the management unit 1604, the installer 1642 obtains the driver from an unshown server connected to the network 1605 or a server on another network connected over the network 1605 and performs the install processing. The setting change monitoring section 1645 and the installer 1642 are configured by executing a program by the management unit 1604.

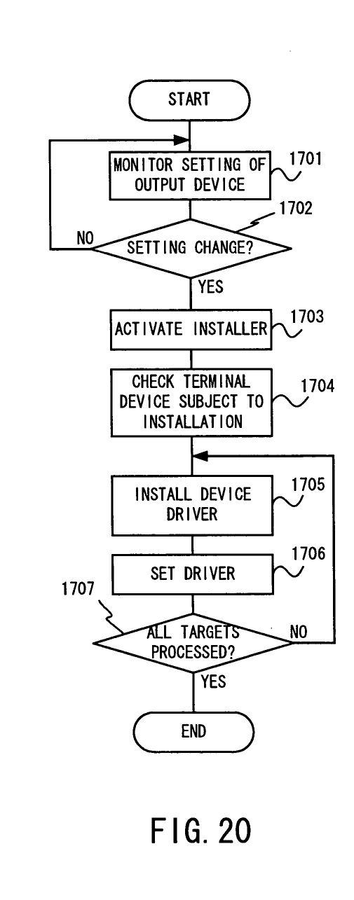

Then, a flow of driver install processing by the driver management system shown in FIG. 19 will be described. FIG. 20 is a flow chart showing a flow of driver install processing by the management unit 1604.

According to this processing, the setting change monitoring section 1645 monitors the output device 1602 (step 1701). When a change in the setting of the output device 1602 is detected (YES in step 1702), the setting change monitoring section 1645 activates the installer 1642 (step 1703). When activated, the installer 1642 refers to the processing objects list 1644 to check the terminal device 1601 into which the driver is installed (step 1704). The installer 1642 installs the driver of the output device 1602 into the previously checked terminal device 1601 (step 1705) and makes setting necessary for the installed driver according to the changed content detected by the setting change monitoring section 1645 (step 1706). And, the installer installs and makes setting of the driver in all terminal devices 1601 under processing (NO in step 1707), and when the driver install into and setting to all the terminal devices 1601 under processing are completed (YES in step 1707), the processing is terminated.

The entire disclosure of Japanese Patent Application No. 2004-070920 filed on Mar. 12, 2004 and Japanese Patent Application No. 2004-076902 filed on Mar. 17, 2004 including specification, claims, drawings and abstract are incorporated herein by reference in their entirety.

1. A driver management method for a driver management unit to manage a device driver to be installed in terminal devices which use a device connected to a network, comprising:
monitoring a driver storage unit in which the device driver for using the device is stored,
when the device driver stored in the driver storage unit is updated, specifying a terminal device into which the updated device driver is installed, and
installing the updated device driver into the specified terminal device.

2. The driver management method according to claim 1, wherein the terminal device which uses the device is managed by the driver management unit, and the managed terminal device is specified as a terminal device into which the device driver is installed.

3. The driver management method according to claim 1, wherein user information about a user who uses the device is managed by the driver management unit, and the terminal device into which the device driver is installed is specified according to the managed user information.

4. The driver management method according to claim 1, wherein user information about a usage-permitted user registered in the device is obtained from the device, and the terminal device into which the device driver is installed is specified according to the obtained user information.

5. The driver management method according to claim 1, wherein, when the device driver stored in the driver storage unit is updated, it is notified to the terminal device specified as a target, into which the device driver is installed, that the device driver is updated, and the device driver is installed in the terminal device which has made an update approval response to the notice.

6. A driver management method for installing a driver corresponding to an output device connected over a network into terminal devices which use the output device, comprising:
detecting that setting of the output device is changed, and
installing the driver corresponding to the output device into the terminal devices on condition that the change is detected.

7. The driver management method according to claim 6, wherein:
the output device detects the setting change and notifies the setting change to the terminal devices when the change is detected; and
the installation in the terminal device is made on condition that the setting change notice is received.

8. The driver management method according to claim 7, wherein the setting change notice is notified by an electronic mail.

9. The driver management method according to claim 6, wherein:
a management unit for installing the driver is connected to the network;
the output device detects the setting change and notifies the setting change to the terminal devices when the change is detected; and
the management unit installs the driver into the terminal devices on condition that the setting change notice is received.

10. The driver management method according to claim 9, wherein the management unit manages a terminal device, into which the driver is installed, among the terminal devices.

11. The driver management method according to claim 6, wherein:
a management unit for installing the driver is connected to the network, and
the management unit monitors that the setting of the output device is changed and installs a driver corresponding to the output device into the terminal devices on condition that the change of the setting of the output device is detected by monitoring.

12. The driver management method according to claim 11, wherein the management unit manages a terminal device, into which the driver is installed, among the terminal devices.

13. A driver management system for installing a driver corresponding to an output device connected over a network into terminal devices which use the output device, comprising:
a setting change detection unit for detecting that setting of the output device is changed; and
an install unit for installing a driver corresponding to the output device into the terminal devices on condition that the change is detected by the setting change detection unit.

14. The driver management system according to claim 13, wherein:
the setting change detection unit is disposed in the output device;
the install unit is disposed in the terminal devices;
the output device is provided with a setting change notification unit which notifies the setting change to the terminal devices when the setting change detection unit detects the change; and
the terminal devices are provided with a setting change notice receiving unit which receives a setting change notice from the setting change notification unit and operates the install unit on condition that it has received the notice.

15. The driver management system according to claim 14, wherein the setting change notification unit notifies the change by an electronic mail.

16. The driver management system according to claim 13, wherein:
the setting change detection unit is disposed in the output device;
the install unit is disposed in a management unit connected to the network;
the output device is provided with a setting change notification unit which notifies the setting change to the management unit when the change is detected by the setting change detection unit; and
the management unit is provided with:
a setting change notice receiving unit which receives a setting change notice from the setting change notification unit and operates the install unit on condition that the notice is received, and
an install target management unit which manages a terminal device, in which a driver is installed by the install unit, among the terminal devices.

17. The driver management system according to claim 13, wherein:
the setting change detection unit and the install unit are disposed in the management unit connected to the network; and
the management unit is provided with an install target management unit which manages a terminal device, into which the driver is installed by the install unit, among the terminal devices.

18. A driver management unit for managing a device driver to be installed in terminal devices which use a device connected to a network, comprising:
a driver storage unit for storing a device driver for using the device;
a target terminal specifying unit for specifying a terminal device into which the device driver stored in the driver storage unit is installed; and
a driver installation unit for installing the device driver into the terminal device specified by the target terminal specifying unit when the device driver stored in the driver storage means is updated.

19. The driver management unit according to claim 18, wherein the target terminal specifying unit is a terminal device management unit for managing the terminal device which uses the device.

20. The driver management unit according to claim 18, wherein:
the target terminal specifying unit is provided with:
a user registration unit for registering a user who uses the device, and
a user information management unit for managing user information on the user registered by the user registration unit; and specifies:
a terminal device for installing the device driver according to the user information managed by the user information management unit.

21. The driver management unit according to claim 18, wherein:
the target terminal specifying unit is provided with:
a user information acquisition unit for obtaining user information on a usage-permitted user registered in the device from the device, and specifies:
a terminal device into which the device driver is installed according to the user information obtained by the user information acquisition unit.

22. The driver management unit according to claim 18, further comprising:
an update notification unit for notifying the terminal device specified by the target terminal specifying unit that the device driver is updated when the device driver stored in the driver storage unit is updated, wherein:
the driver install unit installs the device driver into the terminal device when there is an update approval response to the notice from the update notification unit.

23. A driver management unit which installs a driver corresponding to an output device connected over a network into terminal devices which use the output device, comprising:
a setting change detection unit for detecting that setting of the output device is changed; and
an installation unit for installing a driver corresponding to the output device into the terminal devices on condition that the change is detected by the setting change detection unit.

24. The driver management unit according to claim 23, wherein the setting change detection unit is a setting change notice receiving unit which receives a setting change notice notified from the output device when the setting is changed by the output device.

25. The driver management unit according to claim 24, wherein the setting change notice is notified by an electronic mail.

26. The driver management unit according to claim 23, wherein the setting change detection unit is a setting change monitoring unit for monitoring that the setting is changed by the output device.

27. The driver management unit according to claim 23, further comprising an install target management unit for managing a terminal device, into which a driver is installed by the installation unit, among the terminal devices.

28. A driver management program for managing a device driver which is installed into terminal devices which use a device connected to a network, wherein:
a computer is made to execute:
monitoring processing for monitoring a driver storage unit in which the device driver for using the device is stored;
when the update of the device driver stored in the driver storage unit is detected by the monitoring processing, target specifying processing for specifying a terminal device into which the updated device driver is installed; and
install processing for installing the device driver into the terminal device specified by the target specifying processing.

29. The driver management program according to claim 28, wherein the target specifying processing manages a terminal device using the device by the driver management unit and specifies the managed terminal device as a terminal device into which the device driver is installed.

30. The driver management program according to claim 28, wherein the target specifying processing manages user information on a user who uses the device by the driver management unit and specifies a terminal device, into which the device driver is installed, according to the managed user information.

31. The driver management program according to claim 28, wherein the target specifying processing obtains user information about a usage-permitted user registered in the device from the device and specifies a terminal device, into which the device driver is installed, according to the obtained user information.

32. The driver management program according to claim 28, wherein:
the computer is further made to execute update notification processing for notifying the update of the device driver to the terminal device specified by the target specifying processing when the update of the device driver stored in the driver storage unit is detected by the monitoring processing; and
the install processing installs the device driver into a terminal device which has made an update approval response to the notice by the update notification processing.

33. A driver management program for installing a driver corresponding to an output device connected over a network into terminal devices which use the output device, wherein a computer is made to execute:
setting change detection processing for detecting that the setting of the output device is changed; and
install processing for installing the driver corresponding to the output device into the terminal devices on condition that the change is detected by the setting change detection processing.

34. The driver management program according to claim 33, wherein the setting change detection processing is setting change notice receiving processing for receiving a setting change notice notified from the output device when the setting of the output device is changed.

35. The driver management program according to claim 34, wherein the setting change notice is notified by an electronic mail.

36. The driver management program according to claim 33, wherein the setting change detection processing is setting change monitoring processing for monitoring that the setting is changed by the output device.

37. The driver management program according to claim 33, wherein the computer is further made to execute install target management processing for managing a terminal device, into which the driver is installed by the install processing, among the terminal devices.
